(19) United States
(12) Patent Application Publication
(10) Pub. No.: US 2012/0311048 A1
(43) Pub. Date: Dec. 6, 2012

(54) INSTANT MESSAGING ASSOCIATION METHOD AND SYSTEM

(75) Inventors: James E. Bostick, Cedar Park, TX (US); John M. Ganci, JR., Cary, NC (US); John P. Kaemmerer, Pflugerville, TX (US); Craig M. Trim, Sylmar, CA (US)

(73) Assignee: INTERNATIONAL BUSINESS MACHINES CORPORATION, Armonk, NY (US)

(21) Appl. No.: 13/150,548

(22) Filed: Jun. 1, 2011

(51) Int. Cl. G06F 15/16

(52) U.S. Cl. 709/206

(57) ABSTRACT

A messaging method and system. The method includes enabling by a computing apparatus for a user, an instant messaging software application and all associated contacts to communicate with the user via the instant messaging software application. The computing apparatus enables a software application for the user and presents an option for allowing only a first group of contacts of the associated contacts to communicate with said user. The first group of contacts are associated with the software application. In response, the computing apparatus receives a command associated with the option from the user. The computing apparatus performs functions associated with the first command.

### FIELD OF THE INVENTION

The present invention relates to a method and associated system for associating an instant messaging contact with software applications or folders.

### BACKGROUND OF THE INVENTION

Managing communications between users comprises an inaccurate process with little flexibility. Communication management within a system typically includes a manual process. Manually managing communications may be time consuming and require a large amount of resources. Accordingly, there exists a need in the art to overcome at least some of the deficiencies and limitations described herein above.

### SUMMARY OF THE INVENTION

The present invention provides a method comprising: receiving, by a computer processor of a computing apparatus from a user, a request for access to an instant messaging software application, wherein the computing apparatus comprises a list of contacts associated with the instant messaging software application and the user; enabling for the user, by the computer processor, the instant messaging software application and all contacts of the list of contacts to communicate with the user via the instant messaging software application; enabling for the user, by the computer processor in response to a request from the user, a first specified software application; presenting to the user, by the computer processor in response to the enabling the first specified software application, a first option for allowing only a first group of contacts of the list of contacts to communicate with said user, wherein the first group of contacts are associated with the first specified software application; receiving, by the computer processor from the user, a first command associated with the first option; and performing, by the computer processor in response to the first command, first functions associated with the first command.

The present invention provides a computing system comprising a computer processor coupled to a computer-readable memory unit, the memory unit comprising instructions that when executed by the computer processor implements a method comprising: receiving, by the computer processor from a user, a request for access to an instant messaging software application, wherein the computing apparatus comprises a list of contacts associated with the instant messaging software application and the user; enabling for the user, by the computer processor, the instant messaging software application and all contacts of the list of contacts to communicate with the user via the instant messaging software application; enabling for the user, by the computer processor in response to a request from the user, a first specified software application; presenting to the user, by the computer processor in response to the enabling the first specified software application, a first option for allowing only a first group of contacts of the list of contacts to communicate with the user, wherein the first group of contacts are associated with the first specified software application; receiving, by the computer processor from the user, a first command associated with the first option; and performing, by the computer processor in response to the first command, first functions associated with the first command.

The present invention provides a computer program product, comprising a computer readable storage medium having a computer readable program code embodied therein, the computer readable program code comprising an algorithm that when executed by a computer processor of a computing system implements a method comprising: receiving, by the computer processor from a user, a request for access to an instant messaging software application, wherein the computing apparatus comprises a list of contacts associated with the instant messaging software application and the user; enabling for the user, by the computer processor, the instant messaging software application and all contacts of the list of contacts to communicate with the user via the instant messaging software application; enabling for the user, by the computer processor in response to a request from the user, a first specified software application; presenting to the user, by the computer processor in response to the enabling the first specified software application, a first option for allowing only a first group of contacts of the list of contacts to communicate with the user, wherein the first group of contacts are associated with the first specified software application; receiving, by the computer processor from the user, a first command associated with the first option; and performing, by the computer processor in response to the first command, first functions associated with the first command.

The present invention advantageously provides a simple method and associated system capable of managing communications between users.

### BRIEF DESCRIPTION OF THE DRAWINGS

FIG. 1 illustrates a system for automatically associating instant messenger (privacy) contact lists to software applications and/or folders, in accordance with embodiments of the present invention.

FIG. 2 illustrates a flowchart describing an algorithm used by the system of FIG. 1 for automatically associating instant messenger (privacy) contact lists to software applications and/or folders, in accordance with embodiments of the present invention.

FIGS. 3-7 illustrate flowcharts detailing different embodiments of a step the algorithm of FIG. 2, in accordance with embodiments of the present invention.

FIG. 8 illustrates a computer apparatus used for automatically associating instant messenger (privacy) contact lists to software applications and/or folders, in accordance with embodiments of the present invention.

### DETAILED DESCRIPTION OF THE INVENTION

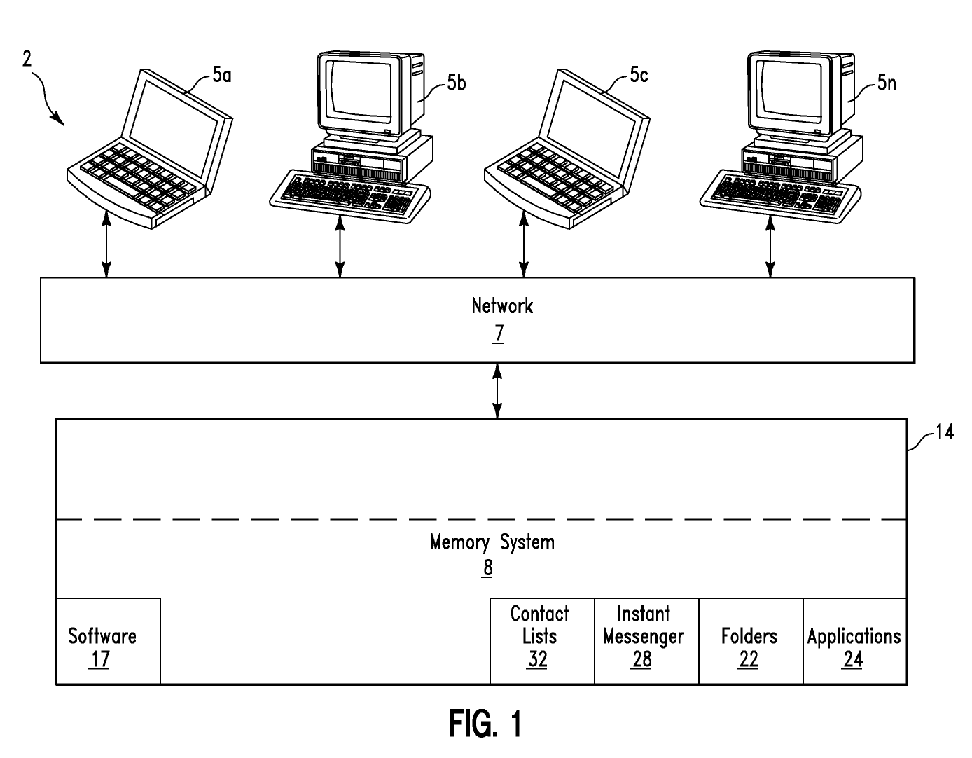

FIG. 1 illustrates a system 2 for automatically associating instant messenger (privacy) contact lists 32 to software applications 24 and/or folders 22, in accordance with embodiments of the present invention. System 2 associates software applications 24 and/or folders 22 to instant messenger software 28 in order to control (privacy) contact lists 32. For example, when a user is using a folder or software application associated with a specified company, a contact (privacy) list is automatically associated with an instant messenger contact group (of a list of contacts) based on a defined configuration and the specified company. Therefore, instant messenger software 28 is automatically adjusted so that the user is only on-line with a group of contacts associated with the specified company. The user would additionally be displayed as off-line to all other contacts of a contact list. System 2 additionally provides a dynamic contact (privacy) list based on activity and location. System 2 enables the following functionality:

1. A system and method for automatically associating specific software applications or folders to instant messaging software for controlling privacy contact lists.
2. Allowing only specified users associated with the specific applications or folders to communicate with a user accessing the specific applications or folders.
3. Allowing only specified users associated with the specific applications or folders to communicate with the user based on location.
4. Allowing only specified users associated with the specific applications or folders to communicate with the user based on specified activities.

System 2 of FIG. 1 comprises computers 5a . . . 5n connected through a network 7 to a computing system 14. Alternatively, computers 5a . . . 5n may be directly connected to computing system 14 (i.e., without network 7). Network 7 may comprise any type of network including, inter alia, a telephone network, a local area network, (LAN), a wide area network (WAN), the Internet, a wireless network, etc. Computers 5a . . . 5n may comprise any type of computing system(s) including, inter alia, a computer (PC), a laptop, a tablet computer, a mobile device, etc. Computing system 14 may comprise any type of computing system(s) including, inter alia, a computer (PC), a server computer, a database computer, etc. Computing system 14 comprises a resource memory system 8. Memory system 8 may comprise a single memory system. Alternatively, memory system 8 may comprise a plurality of memory systems. Memory system 8 comprises software applications 24, folders 22, instant messenger software 28, contact lists 32, and a software application 17 for automatically associating instant messenger (privacy) contact lists 32 to software applications 24 and/or folders 22. Alternatively, software applications 24, folders 22, instant messaging software 28, contact lists 32, and/or a software application 17 may be located on each of computers 5a . . . 5n.

The following implementation example describes a process performed by system 2 for automatically associating instant messenger (privacy) contact lists 32 to software applications 24 and/or folders 22:

A user A has access to an instant messenger software application and associated instant messenger contacts divided into groups. Each group of contacts is associated with a different business associated with (e.g., doing business with) user A. For example, a first group contacts is associated with a first company and a second group of contacts is associated with a second company. When user A is working on a specific application or accesses a specific folder in a specific file, system 2 provides a capability to automatically set privacy contact lists based on individuals or groups associated with a specified business and the specific application or specific folder. In this example, user A uses a software application companyA.exe to test certain scenarios for work at company A. Additionally, user A uses a software application companyB.exe for word processing work for company B. An entire output of a multi-week project at company B is a word processing document titled B.wp.

The following steps describe the implementation example enabled by system 2:

1. User A logs into a computer (e.g., any of computers 5a . . . 5n and/or computing system 14) and enables an instant messenger (e.g., instant messenger software application 28).
2. User A checks incoming email and works on communications within his/her department. During these transactions, the instant messenger allows communications between user A and all contacts on user A's contact (privacy) list.
3. User A enables the software application companyA.exe (i.e., to test certain scenarios for work at company A). In this scenario, user A has previously set up a link between a company A instant messenger group of contacts (i.e., of user A's contact (privacy) list) and the software application companyA.exe.
4. As the software application companyA.exe boots up, system 2 presents user A with an option of automatically setting on user A's contact (privacy) list so that only the company A instant messenger group of contacts (i.e., of user A's contact (privacy) list) can communicate with user A online. In response, system 2 presents user A with the following choices:

A. A choice for not automatically setting user A's contact (privacy) list so that only the company A instant messenger group of contacts (i.e., of user A's contact (privacy) list) can communicate with user A online. In this instance, the instant messenger allows communications between user A and all contacts on user A's contact (privacy) list.

B. A choice for automatically setting user A's contact (privacy) list so that only the company A instant messenger group of contacts (i.e., of user A's contact (privacy) list) can communicate with user A online. In this example, user A selects automatically setting the contact (privacy) list to company A contacts.

5. At a later time, user A disables the software application companyA.exe. At this time, the instant messenger presents user A with the option of communicating with all contacts or just the company A contacts. Alternatively, system 2 may be configured so that an automatic selection is made without user A input.
6. At a later time, user A enables the document titled B.wp in software application companyB.exe. In this scenario, user A has previously set up a link between a company A instant messenger group of contacts (i.e., of user A's contact (privacy) list) and the software application companyA.exe.
7. As the software application companyB.exe boots up, system 2 presents user A with an option of automatically setting on user A's contact (privacy) list so that only the company B instant messenger group of contacts (i.e., of user A's contact (privacy) list) can communicate with user A online. In response, system 2 presents user A with the following choices:

A. A choice for not automatically setting user A's contact (privacy) list so that only the company B instant messenger group of contacts (i.e., of user A's contact (privacy) list) can communicate with user A online. In this instance, the instant messenger allows communications between user A and all contacts on user A's contact (privacy) list.

B. A choice for automatically setting user A's contact (privacy) list so that only the company B instant messenger group of contacts (i.e., of user A's contact (privacy) list) can communicate with user A online. In this example, user A selects automatically setting the contact (privacy) list to company B contacts.

8. Additionally, there may be a time in the day when applications or folders are tied back to more than one contact (privacy) group of contacts. For example, the software application companyA.exe and the software application companyB.exe are both enabled. In this case, an additional choice (or drop down menu list) may be presented so that user A may select which groups of contacts remain in communication with user A. Additionally, groups of contacts may be tied to specified folders, locations, and/or specified activities for user A and the groups of contacts.

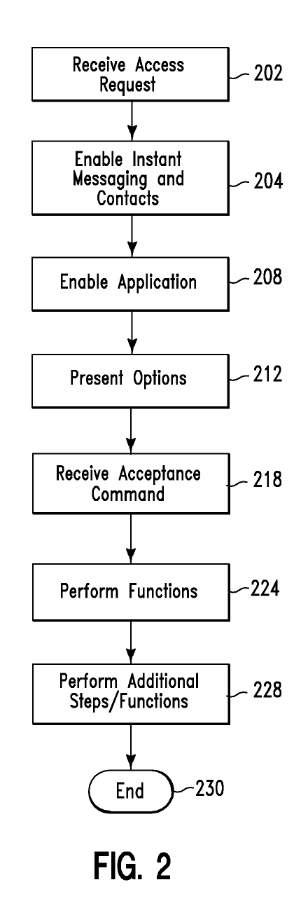

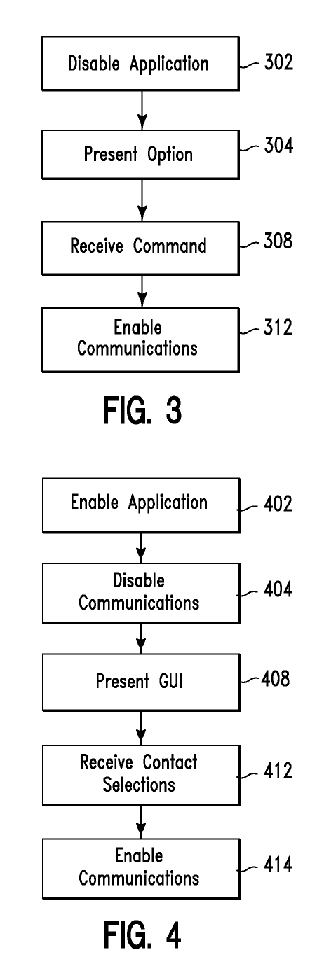

FIG. 2 illustrates a flowchart describing an algorithm used by system 2 of FIG. 1 for automatically associating instant messenger (privacy) contact lists 32 to software applications 24 and/or folders 22, in accordance with embodiments of the present invention. In step 202, (a computer processor of) a computing apparatus (e.g., computing system 14 of FIG. 1) receives (from a user) a request for access to an instant messaging software application (e.g., instant messenger software 28 of FIG. 1). The computing apparatus may include a list of contacts (e.g., contact lists 32 of FIG. 1) associated with the instant messaging software application and the user. In step 204, the computing apparatus enables (for the user) the instant messaging software application and all contacts of the list of contacts to communicate with the user via the instant messaging software application. In step 208, the computing apparatus enables (for the user in response to a request from the user) a first specified software application. In step 212, the computing apparatus presents (to the user in response to enabling the first specified software application) a first option for allowing only a first group of contacts of the list of contacts to communicate with the user. The first group of contacts is associated with the first specified software application. In step 218, the computing apparatus receives (from the user) an acceptance command associated with the first option. In step 224, the computing apparatus performs (in response to the acceptance command) functions associated with the acceptance command. The functions may include disabling all communications between the user and a second group of contacts (of the list of contacts) that are not comprised by the first group of contacts. Communications between the user and the first group of contacts remain enabled. The communications between the user and the first group of contacts is based on an association with the first specified software application. In step 228, the computing apparatus performs additional steps and functions associated with various embodiment of the present invention as described, infra, with respect to FIGS. 3-7 and the process is terminated in step 230.

FIG. 3 illustrates a flowchart detailing a first embodiment of step 228 of FIG. 2, in accordance with embodiments of the present invention. In step 302, the computing apparatus disables (in response to a request from the user) the first specified software application. In step 304, the computing apparatus presents (to the user in response to step 302) a second option for allowing all of the contacts of the contact list to communicate with the user. In step 308, the computing apparatus receives a second command associated with the second option. In step 312, the computing apparatus enables (in response to the second command) communications between the user and all contacts on the contact list.

FIG. 4 illustrates a flowchart detailing a second embodiment of step 228 of FIG. 2, in accordance with embodiments of the present invention. In step 402, the computing apparatus enables (in response to a request from the user) a second specified software application. In step 404, the computing apparatus disables all communications between the user and the first group of contacts. In step 408, the computing apparatus presents (to the user in response to step 402) a graphical user interface for selecting contacts of the contact list to communicate with the user. In step 412, the computing apparatus receives (from the user via the graphical user interface) contact selections. In step 414, the computing apparatus enables (in response to the contact selections) communications between the user and selected groups of contacts.

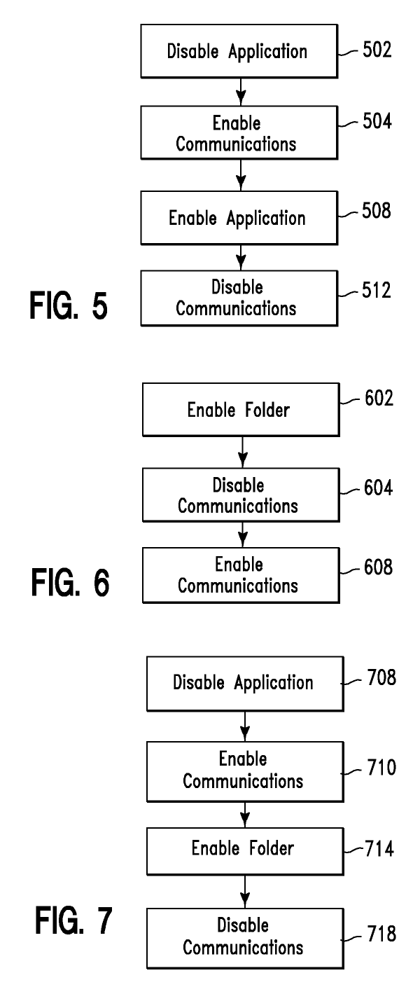

FIG. 5 illustrates a flowchart detailing a third embodiment of step 228 of FIG. 2, in accordance with embodiments of the present invention. In step 502, the computing apparatus disables (in response to a request from the user) the first specified software application. In step 504, the computing apparatus enables (in response to step 502) communications between the user and all contacts on the contact list. In step 508, the computing apparatus enables (in response to a request from the user) a second specified software application. In step 512, the computing apparatus disables (in response to enabling the second specified software application) communications between the user and the first group of contacts. Communications between the user and the second group of contacts remain enabled. The second group of contacts is associated with the second specified software application.

FIG. 6 illustrates a flowchart detailing a fourth embodiment of step 228 of FIG. 2, in accordance with embodiments of the present invention. In step 602, the computing apparatus enables for the user (in response to a request from the user) a specified folder. In step 604, the computing apparatus disables (in response to enabling the specified folder) communications between the user and the first group of contacts. In step 608, the computing apparatus enables (for the user in response to enabling the specified folder) communications between the user and the second group of contacts (i.e., the second group of contacts are associated with the specified folder).

FIG. 7 illustrates a flowchart detailing a fifth embodiment of step 228 of FIG. 2, in accordance with embodiments of the present invention. In step 708, the computing apparatus disables (for the user in response to a request from the user) the first specified software application. In step 710, the computing apparatus enables (for the user in response to disabling the first specified software application) communications between the user and all contacts. In step 714, the computing apparatus enables (for the user in response to a request from the user) a specified folder. In step 718, the computing apparatus disables (in response to enabling the specified folder) communications between the user and the first group of contacts of the contact list. The second group of contacts is associated with the specified folder.

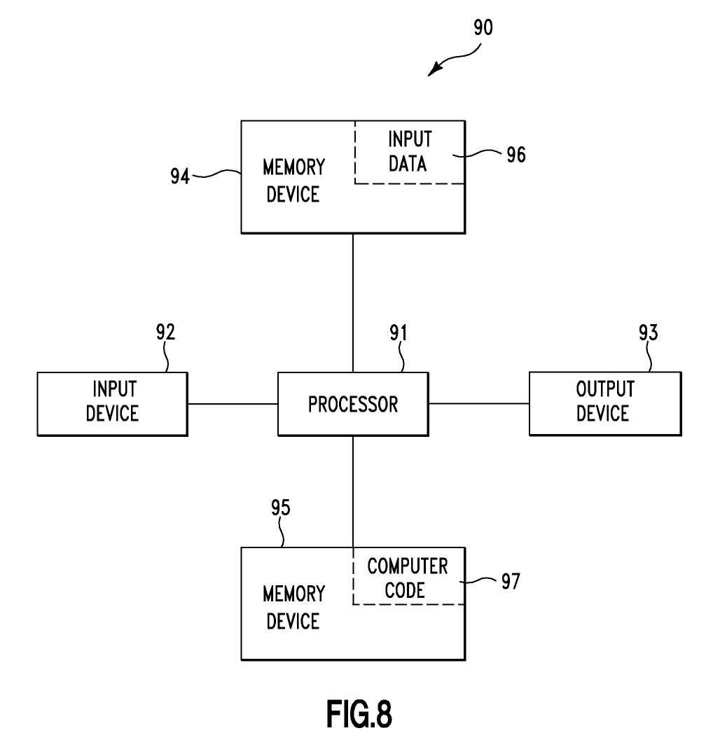

FIG. 8 illustrates a computer apparatus 90 (e.g., computing system 14 of FIG. 1) used for associating instant messenger (privacy) contact lists to software applications and/or folders, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithms of FIGS. 2-7) for associating instant messenger (privacy) contact lists to software applications and/or folders. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 8) may comprise the algorithms of FIGS. 2-7 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise the computer usable medium (or said program storage device).

Still yet, any of the components of the present invention could be created, integrated, hosted, maintained, deployed, managed, serviced, etc. by a service supplier who offers to associate instant messenger (privacy) contact lists to software applications and/or folders. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for associating instant messenger (privacy) contact lists to software applications and/or folders. In another embodiment, the invention provides a business method that performs the process steps of the invention on a subscription, advertising, and/or fee basis. That is, a service supplier, such as a Solution Integrator, could offer to associate instant messenger (privacy) contact lists to software applications and/or folders. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method, comprising:
receiving, by a computer processor of a computing apparatus from a user, a request for access to an instant messaging software application, wherein said computing apparatus comprises a list of contacts associated with said instant messaging software application and said user;
enabling for said user, by said computer processor, said instant messaging software application and all contacts of said list of contacts to communicate with said user via said instant messaging software application;
enabling for said user, by said computer processor in response to a request from said user, a first specified software application;
presenting to said user, by said computer processor in response to said enabling said first specified software application, a first option for allowing only a first group of contacts of said list of contacts to communicate with said user, wherein said first group of contacts are associated with said first specified software application;
receiving, by said computer processor from said user, a first command associated with said first option; and
performing, by said computer processor in response to said first command, first functions associated with said first command.

2. The method of claim 1, wherein said first command indicates acceptance of said first option, and wherein said performing said first functions comprise:
disabling all communications between said user and a second group of contacts of said list of contacts, wherein said second group of contacts are not comprised by said first group of contacts, wherein communications between said user and said first group of contacts remain enabled, and wherein said communications between said user and said first group of contacts is based on an association with said first specified software application.

3. The method of claim 2, further comprising:
disabling for said user, by said computer processor in response to a request from said user, said first specified software application;
presenting to said user, by said computer processor in response to said disabling said first specified software application, a second option for allowing all said contacts of said list of contacts to communicate with said user;
receiving, by said computer processor from said user, a second command associated with said second option; and
enabling, by said computer processor in response to said second command, communications between said user and all said contacts.

4. The method of claim 2, further comprising:
enabling for said user, by said computer processor in response to a request from said user, a second specified software application;
disabling for said user, by said computer processor, all communications between said user and said first group of contacts;
presenting to said user, by said computer processor in response to said enabling said second specified software application, a graphical user interface for selecting contacts of said list of contacts to communicate with said user;
receiving, by said computer processor from said user via said graphical user interface, contact selections; and
enabling, by said computer processor in response to said contact selections, communications between said user and selected groups of contacts of said list of contacts.

5. The method of claim 2, further comprising:
disabling for said user, by said computer processor in response to a request from said user, said first specified software application;
enabling for said user, by said computer processor in response to said disabling said first specified software application, communications between said user and all said contacts;
enabling for said user, by said computer processor in response to a request from said user, a second specified software application; and
disabling, by said computer processor in response to said enabling said second specified software application, communications between said user and said first group of contacts of said list of contacts, wherein said second group of contacts are associated with said second specified software application, and wherein communications between said user and said second group of contacts remain enabled.

6. The method of claim 2, further comprising:
enabling for said user, by said computer processor in response to a request from said user, a specified folder;
disabling, by said computer processor in response to said enabling said specified folder, communications between said user and said first group of contacts of said list of contacts; and
enabling for said user, by said computer processor in response to said enabling said specified folder, communications between said user and said second group of contacts, wherein said second group of contacts are associated with said specified folder.

7. The method of claim 2, further comprising:
disabling for said user, by said computer processor in response to a request from said user, said first specified software application;
enabling for said user, by said computer processor in response to said disabling said first specified software application, communications between said user and all said contacts;
enabling for said user, by said computer processor in response to a request from said user, a specified folder; and
disabling, by said computer processor in response to said enabling said specified folder, communications between said user and said first group of contacts of said list of contacts, wherein said second group of contacts are associated with said specified folder, and wherein communications between said user and said second group of contacts remain enabled.

8. The method of claim 2, further comprising:
determining, by said computer processor, a specified location associated with said first group of contacts, wherein said communications between said user and said first group of contacts is further based on said first group of contacts being associated with said specified location.

9. The method of claim 2, further comprising:
determining, by said computer processor, specified computer activities being performed by said first group of contacts, wherein said communications between said user and said first group of contacts is further based on said specified computer activities being performed by said first group of contacts.

10. The method of claim 1, further comprising:
providing a process for supporting computer infrastructure, said process comprising providing at least one support service for at least one of creating, integrating, hosting, maintaining, and deploying computer-readable code in the computing system, wherein the code in combination with the computing system is capable of performing the method of claim 1.

11. A computing system comprising a computer processor coupled to a computer-readable memory unit, said memory unit comprising instructions that when executed by the computer processor implements a method comprising:
receiving, by said computer processor from a user, a request for access to an instant messaging software application, wherein said computing apparatus comprises a list of contacts associated with said instant messaging software application and said user;
enabling for said user, by said computer processor, said instant messaging software application and all contacts of said list of contacts to communicate with said user via said instant messaging software application;
enabling for said user, by said computer processor in response to a request from said user, a first specified software application;
presenting to said user, by said computer processor in response to said enabling said first specified software application, a first option for allowing only a first group of contacts of said list of contacts to communicate with said user, wherein said first group of contacts are associated with said first specified software application;
receiving, by said computer processor from said user, a first command associated with said first option; and
performing, by said computer processor in response to said first command, first functions associated with said first command.

12. The computing system of claim 11, wherein said first command indicates acceptance of said first option, and wherein said performing said first functions comprise:
disabling all communications between said user and a second group of contacts of said list of contacts, wherein said second group of contacts are not comprised by said first group of contacts, wherein communications between said user and said first group of contacts remain enabled, and wherein said communications between said user and said first group of contacts is based on an association with said first specified software application.

13. The computing system of claim 12, wherein said method further comprises:
disabling for said user, by said computer processor in response to a request from said user, said first specified software application;
presenting to said user, by said computer processor in response to said disabling said first specified software application, a second option for allowing all said contacts of said list of contacts to communicate with said user;
receiving, by said computer processor from said user, a second command associated with said second option; and
enabling, by said computer processor in response to said second command, communications between said user and all said contacts.

14. The computing system of claim 12, wherein said method further comprises:
enabling for said user, by said computer processor in response to a request from said user, a second specified software application;
disabling for said user, by said computer processor, all communications between said user and said first group of contacts;
presenting to said user, by said computer processor in response to said enabling said second specified software application, a graphical user interface for selecting contacts of said list of contacts to communicate with said user;
receiving, by said computer processor from said user via said graphical user interface, contact selections; and
enabling, by said computer processor in response to said contact selections, communications between said user and selected groups of contacts of said list of contacts.

15. The computing system of claim 12, wherein said method further comprises:
disabling for said user, by said computer processor in response to a request from said user, said first specified software application;
enabling for said user, by said computer processor in response to said disabling said first specified software application, communications between said user and all said contacts;
enabling for said user, by said computer processor in response to a request from said user, a second specified software application; and
disabling, by said computer processor in response to said enabling said second specified software application, communications between said user and said first group of contacts of said list of contacts, wherein said second group of contacts are associated with said second specified software application, and wherein communications between said user and said second group of contacts remain enabled.

16. The computing system of claim 12, wherein said method further comprises:
enabling for said user, by said computer processor in response to a request from said user, a specified folder;
disabling, by said computer processor in response to said enabling said specified folder, communications between said user and said first group of contacts of said list of contacts; and
enabling for said user, by said computer processor in response to said enabling said specified folder, communications between said user and said second group of contacts, wherein said second group of contacts are associated with said specified folder.

17. The computing system of claim 12, wherein said method further comprises:
disabling for said user, by said computer processor in response to a request from said user, said first specified software application;
enabling for said user, by said computer processor in response to said disabling said first specified software application, communications between said user and all said contacts;
enabling for said user, by said computer processor in response to a request from said user, a specified folder; and
disabling, by said computer processor in response to said enabling said specified folder, communications between said user and said first group of contacts of said list of contacts, wherein said second group of contacts are associated with said specified folder, and wherein communications between said user and said second group of contacts remain enabled.

18. The computing system of claim 12, wherein said method further comprises:
determining, by said computer processor, a specified location associated with said first group of contacts, wherein said communications between said user and said first group of contacts is further based on said first group of contacts being associated with said specified location.

19. The computing system of claim 12, wherein said method further comprises:
determining, by said computer processor, specified computer activities being performed by said first group of contacts, wherein said communications between said user and said first group of contacts is further based on said specified computer activities being performed by said first group of contacts.

20. A computer program product, comprising a computer readable storage medium having a computer readable program code embodied therein, said computer readable program code comprising an algorithm that when executed by a computer processor of a computing system implements a method comprising:
receiving, by said computer processor from a user, a request for access to an instant messaging software application, wherein said computing apparatus comprises a list of contacts associated with said instant messaging software application and said user;
enabling for said user, by said computer processor, said instant messaging software application and all contacts of said list of contacts to communicate with said user via said instant messaging software application;
enabling for said user, by said computer processor in response to a request from said user, a first specified software application;
presenting to said user, by said computer processor in response to said enabling said first specified software application, a first option for allowing only a first group of contacts of said list of contacts to communicate with said user, wherein said first group of contacts are associated with said first specified software application;
receiving, by said computer processor from said user, a first command associated with said first option; and
performing, by said computer processor in response to said first command, first functions associated with said first command.
